(19) United States
(12) Patent Application Publication
(10) Pub. No.: US 2024/0317953 A1
(43) Pub. Date: Sep. 26, 2024

(54) Coated Film

(71) Applicants: DOW GLOBAL TECHNOLOGIES LLC, Midland, MI (US); ROHM AND HAAS COMPANY, Collegeville, PA (US)

(72) Inventors: Yinzhong Guo, Lake Jackson, TX (US); Zhenwan Fu, Collegeville, PA (US); Jie Wu, Lake Jackson, TX (US)

(21) Appl. No.: 18/275,157

(22) PCT Filed: Dec. 9, 2021
(86) PCT No.: PCT/US21/62634

§ 371 Date: Jul. 31, 2023

Related U.S. Application Data
(60) Provisional application No. 63/143,124, filed on Jan. 29, 2021.

(51) Int. Cl. C08J 7/04; B65D 65/42; C08J 7/046; C08J 7/052; C08J 11/06; C09D 5/02; C09D 7/43; C09D 175/00

(52) U.S. Cl. CPC C08J 7/0427; B65D 65/42; C08J 7/046; C08J 7/052; C08J 11/06; C09D 5/022; C09D 7/43; C09D 175/00; B65D 2565/385; C08J 2323/06; C08J 2475/00

(57) ABSTRACT

A glossy coated film having recyclability properties comprising a combination of: (a) at least one film layer of a recyclable polyolefin; and (b) at least one coating layer: wherein the at least one coating layer comprises a waterborne coating composition and a water-dispersible polyisocyanate; and wherein the coating layer has a recyclability property; and wherein the at least one coating layer is disposed on at least a portion of the surface of one side of the at least one film layer of the recyclable polyolefin.

### FIELD

The present invention is related to a coated film; and more specifically, the present invention is related to a coated film including a combination of (a) a polyolefin polymer layer and (b) a waterborne coating layer having a beneficial recyclability property.

### BACKGROUND

As the production capacity and global consumption of plastics continuously increase, the accumulative and irreparable damage to the ecosystem caused by plastic wastes becomes a growing concern that is widespread known to the public. Flexible packaging industry is one of the major territories dominantly occupied by plastic articles. Therefore, film manufacturers, packaging converters, and brand owners, are all urgently seeking for a path to reduce or more ideally to eliminate plastic pollution. Among the approaches to provide a sustainable solution to significantly minimize or eliminate the plastic pollution problem is to develop new, recyclable plastics packaging materials. Converters and manufacturers of packaging products have already initiated plans to target a 100 percent (%) recyclable or compostable packaging article for packaging various products.

Traditional flexible packaging designs are typically based on laminating various functional layers composed of different materials like polyethylene terephthalate (PET), bi-axially oriented polypropylene (BOPP), metalized PET, metalized oriented polypropylene (OPP), aluminum foils, nylon/polyimides, and the like. The above functional layers which provide a printable or barrier layer are commonly laminated with a sealable layer such as low density polyethylene (LDPE) or sealable OPP, and the like, through an adhesive layer. Because of the different materials laminated together, the generated flexible packaging material becomes non-recyclable; and an economically practical and technically efficient process to separate the various different films (and layers) and recycle each material individually is yet to be discovered.

For example, lamination of different polyolefin film layers together, such as high density polyethylene (HDPE) and low density polyethylene (LDPE), bi-axially oriented polyethylene (BOPE) and LDPE, BOPP and LDPE, BOPE and BOPP, and the like, using conventional adhesives that are either acrylic or polyurethane (PU) based, is a huge challenge to provide a recyclability property to plastic packaging materials from the above resultant laminated films. The conventional laminating adhesives used in laminating the above films are so dissimilar to polyolefin in the backbone chemistry and are usually highly crosslinked, that the feasibility of making this traditional packaging design ready for recycle is very limited. In order to achieve package material mechanical recyclability, making a package film from a single type material is preferred and expected; however, the material must be heat sealable to make packaging articles such as pouches, and generally the scalable polyolefin films, even those made from HDPE, have a lower thermal anti-seal resistance, which makes it almost impossible to directly use the single type material film for making a packaging material.

Heretofore, one method used for making a heat sealable polyolefin film is to coat a polyolefin film with a solvent-based PU glossy coating made from polyol components in combination with an aromatic polyisocyanate in an organic solvent such that the coated film is thermally resistance under scaling conditions. For example, WO2020005927A1. WO2019240921A1, and WO2016196168A1 disclose coated films and articles formed from such films where the coated film comprises (a) an ethylene-based polymer film; and (b) a PU coating wherein the coated film is thermally resistant under sealing conditions. However, the solvent-based coating has recyclability limitations.

Heretofore, another method used for making a heat sealable polyolefin film is to coat a polyolefin film with an aqueous-based coating. For example, U.S. Pat. No. 5,188,867A discloses thermoplastic films coated with an aqueous acrylic copolymer in combination with solid materials dispersed in the acrylic copolymer. The above patent provides an acrylic coating comprising an acrylic emulsion, an inorganic blocking agent and a wax slip agent, which is applied to the polyolefin film. In another example, Canadian Patent No. CA2381315C discloses a method for producing a high gloss coating on a printed surface film using a water based aqueous coating comprising a film-forming coating polymer, additives and pigments. While the above known methods provide a coated heat sealable polyolefin film, the known methods use a coating formulation with additives containing solid materials such as inorganic pigment particles; and thus, do not provide a coated polyolefin film having recyclability properties.

### SUMMARY

One objective of the present invention is to provide a recyclable glossy coated polyolefin film useful for packaging applications, wherein the coated film has thermal seal resistant and abrasion resistance properties; and wherein one side of the polyolefin film has a coating layer made from a waterborne (WB) acrylic coating composition formulated with a hydroxyl functionalize emulsion and additives without containing inorganic pigment particles.

Another objective of the present invention is to provide a heat sealable coated polyolefin film that can be constructed from a polyolefin-only material and can be used for making an article such as a packaging material to achieve a mechanical recyclable packaging material. The use of heat sealable and recyclable polyolefin films would be a huge step in helping converters and manufacturers mitigate the plastics pollution problem.

In accordance with the present invention, heat sealable and recyclable polyolefin films are made having a heat sealable property on one side of the film; and concurrently, having an anti-seal (i.e., a thermal seal resistance) property on the other side of the film via a novel heat seal resistant coating layer. In one embodiment, the heat seal resistant coating layer includes a novel formulated WB acrylic coating crosslinked with water-dispersible polyisocyanates. In a preferred embodiment, the WB acrylic coating is formulated from a hydroxyl functionalize acrylic emulsion and additives; and the WB coating does not contain inorganic pigment particles.

The thermal seal resistant coating layer advantageously provides polyolefin films with a high gloss (i.e., an enhanced HDPE transparency and a package color fidelity) property, an anti-seal property at above 205 degrees Celsius (° C.), a lower coefficient of friction (COF) property, and a significant increase in the polyolefin films abrasion resistance property. Using the coated polyolefin films having the coating of the present invention, makes it possible to construct an overall polyolefin-only packaging material for packaging applications; and achieves the beneficial mechanical recyclability of the packaging material. In addition to the film having advantageous recyclable properties, other beneficial properties of the film include a long pot life, and a high abrasion resistance.

In accordance with one embodiment, the present invention is directed to a thermal seal resistant and recyclable coated polyolefin film; wherein the coated film includes a combination of: (a) a recyclable polyolefin polymer layer; and (b) a WB acrylic-based high gloss coating layer having a recyclability property.

In some embodiments, the present invention includes a process for producing the above coated film.

In some embodiments, the present invention includes a first article made from the above coated film such as pellets, a monolayer film, a multilayer film, a monolayer laminate, a multilayer laminate, a packaging material, a molded product, and the like.

In some embodiments, the present invention includes a subsequent second article made from the recycled material originating from any one of the above first articles.

Advantageously, the first article made incorporating the above WB acrylic-based glossy coating film can be subjected to a recycling process in accordance with current recyclability guidelines for the packaging industry. For example, utilizing the WB acrylic-based coating composition of the present invention, which is an acrylic-based system, in combination with a polymer film structure, such as an all-polyethylene high density polyethylene film or an all-polypropylene film, provides a film structure that can be reprocessed to make a new second article with properties and performance that are substantially the same as the first article.

### DETAILED DESCRIPTION

“Recyclable” and “recyclability” herein, with reference to a polyolefin film article having a WB acrylic-based coating, means mechanical recyclable or recyclability; and means the film article with a WB acrylic-based coating is mechanically re-processable to generate another subsequent recycled article having a desirable performance and desirable properties.

“Heat-scalable” and “heat-scalability” herein, with reference to a polyolefin film article, means a film having two sides wherein one side of the film is coated with a coating layer and wherein the other side of the film not coated; and wherein the non-coated side of the film is heat scalable and the coated side of the film is not heat-scalable.

In one broad embodiment, the present invention includes a recyclable coated film structure for producing packaging materials that can be recycled at the storefront. The recyclable coated film includes the combination of at least one heat-scalable recyclable polyolefin film layer substrate coated with a coating layer; the coating layer being disposed on at least a portion of one surface of the polyolefin film layer.

According to one or more embodiments of the present invention, the polyolefin film layer, component (a) of the heat-scalable, recyclable coated film structure, includes, for example, a polyolefin film comprising an ethylene-based polymer; and the coating layer, component (b) of the heat-scalable, recyclable coated film structure, includes, for example, a recyclable WB acrylic-based high gloss coating layer having a recyclability property; and wherein the recyclable WB coating layer is compatible with the polyolefin layer. Generally, the recyclable polymer film layer has an outer (or external or top) surface and an inner (or internal or bottom) surface; and the coating layer has an outer (or external or top) surface and an inner (or internal or bottom) surface. At least a portion of the internal surface of the coating layer is in contact with at least a portion of the external surface of the polyolefin film layer. In a preferred embodiment, the outer surface of the coating layer forms the outer surface of the overall coated film structure (i.e., polyolefin layer plus coating layer). For example, in a general embodiment the coated film of the present invention includes (a) at least one polyolefin film layer such as a polyethylene (PE) film; and (b) a WB acrylic-based coating layer bonded to the polyolefin film. One or more other optional film layer substrates can be added to the above film structure to produce a multi-layer film structure, if desired.

In one or more embodiments, the polyolefin film web or layer, component (a), used for making the film structure of the present invention can include a single layer (monolayer) made of one or more polyolefins or olefinic polymers; or the film structure can include a multilayer structure made of one or more polyolefin layers. The term, “olefin-based polymer.” “olefinic polymer,” and “polyolefin.” as used herein, refer to a polymer that comprises, in polymerized form, a majority amount of olefin monomer, for example, ethylene or propylene (based on the weight of the polymer) and, optionally, may comprise one or more comonomers. The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers.

In other embodiments, the polyolefin film of the present invention may be a multilayer film which contains more than one layer. As described herein, a “multilayer film” means any film having more than one layer. For example, the multilayer film may have two, three, four, five or more layers. A multilayer film may be described as having the layers designated with letters to assist in describing the film. For example, a three-layer film having a core layer B. and two external layers A and C may be designated as A/B/C. Likewise, a structure having two core layers B and C and two external layers A and D would be designated A/B/C/D. In some embodiments, the polyolefin films may be coextruded films with an odd number of layers from 3 to 35, such as from 3 to 11 or from 3 to 7. For example, in some embodiments, the polyolefin film layer may be a three-layer multilayer film comprised of three layers of polyethylene.

In one or more embodiments, the polyolefin layer may comprise an ethylene-based polymer. As described herein, “polyethylene” or an “ethylene-based polymer” shall mean polymers comprising greater than (>) 50% by mole (mol %) of units derived from ethylene monomer. This includes ethylene-based homopolymers or copolymers (meaning units derived from two or more comonomers). Common forms of polyethylene known in the art include, but are not limited to, LDPE; linear low density polyethylene (LLDPE); ultra low density polyethylene (ULDPE); very low density polyethylene (VLDPE); single-site catalyzed LLDPE, including both linear and substantially linear low density resins (m-LLDPE); medium density polyethylene (MDPE); and HDPE. For example, the polyolefin layer, can include one or more polyolefin layers such as HDPE, LDPE, LLDPE, MDO PE, BOPE, and mixtures thereof.

In one preferred embodiment, the polyolefin film layer can include oriented single or multilayer PE films made using either machine direction or biaxial orientation processes which is bonded to a second layer.

In another preferred embodiment, the polyolefin film layer can be a multilayer film comprised one or more layers of HDPE, LLDPE, and LDPE.

In still another preferred embodiment, the polyolefin film layer can be a polypropylene (PP) film or a BOPP film layer.

In yet another preferred embodiment, the polyolefin film layer can be a film layer of copolymer of polyethylene and propylene.

The thickness of the first polyolefin film layer used to form the heat sealable recyclable film of the present invention can be, for example, from 12 microns (μm) to 500 μm in one embodiment, from 20 μm to 250 μm in another embodiment and from 25 μm to 100 μm in still another embodiment.

Additionally, as described herein, the term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 megaPascals [MPa]) with the use of free-radical initiators, such as peroxides (see, for example, U.S. Pat. No. 4,599,392). LDPE resins typically have a density in the range of 0.916 grams per cubic centimeter (g/cm³) to 0.940 g/cm³.

The term “LLDPE”, as described herein, may include resins made using ZieglerNatta catalyst systems as well as resin made using single-site catalysts, including, but not limited to, bis-metallocene catalysts (sometimes referred to as “m-LLDPE”), phosphinimine, and constrained geometry catalysts; and resin made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined, for example, in U.S. Pat. Nos. 5,272,236; 5,278,272; 5,582,923; and 5,733,155; the homogeneously branched ethylene polymers such as those described in U.S. Pat. No. 3,645,992; the heterogeneously branched ethylene polymers such as those prepared according to the process disclosed in U.S. Pat. No. 4,076,698; and blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art. The LLDPE resins can be made via gas-phase, solution-phase, or slurry polymerization or any combination thereof, using any type of reactor or reactor configuration known in the art.

Additionally, as described herein, the term “HDPE” refers to polyethylenes having densities of about 0.940 g/cm³ or greater, which are generally prepared with Ziegler-Natta catalysts, chrome catalysts or even metallocene catalysts. In one or more embodiments, the polyolefin film layer may be a multilayer film which includes an outer layer comprising an ethylene-based polymer.

Examples of such ethylene-based polymers may include those commercially available from Dow Inc but not limited including, for example, ELITE™ 5960G, ELITE™ 5390, DOW™ DGDP-6097. DOW™ DMDA-8905NT. DOW™ DGDC-2100NT, and similar known polymers commercially available from Dow Inc. or other suppliers such as Exxon Mobil.

In one or more embodiments, the polyolefin film layer may have a thickness of less than or equal to (≤) 1 millimeter (mm), such as ≤900 μm, ≤800 μm, ≤700 μm, ≤600 μm, ≤500 μm, ≤400 μm, ≤300 μm, or even ≤200 μm. The polyolefin film layer may have a thickness of greater than or equal to (≥) 1 μm, ≥5 μm, ≥10 μm, ≥20 μm, ≥30 μm, ≥40 μm, or even ≥50 μm. As is understood by those skilled in the art, in multilayer films, the thicknesses of the different layers can be the same or different; and layer thicknesses may be selected by techniques known to those having skill based on the disclosure herein.

In still other embodiments, the polyolefin film layer of the coated polyolefin film may include the laminations of various different polyolefin films laminated together with recyclable laminating adhesives.

The coating layer of the film structure, component (b), used to coat the polyolefin layer is advantageously formed from a coating composition that has a recyclability property. An article, for example a packaging article, manufactured from the film structure containing the recyclable coating is imparted with an acceptable recyclability to the packaging article made from the recyclable film structure.

In one embodiment, the WB coating composition useful in the present invention includes, for example, a novel formulated WB acrylic coating crosslinked with water-dispersible polyisocyanates. In a preferred embodiment, the WB acrylic coating is formulated from a hydroxyl functionalize acrylic emulsion and additives other than inorganic pigment particles. In some preferred embodiments, the additives can include, for example, coalescing agents, rheology modifiers, wetting agents, dispersants, slip agents and mixtures thereof. In one preferred embodiment, the coating composition can include, for example, acrylates, polyesters, polycarbonates, and; and mixtures thereof.

In one embodiment, the water-dispersible polyisocyanate crosslinkers may include water-dispersible aliphatic polyisocyanates, for example, MOR-FREE CR 9-101 commercially available from Dow Inc.

The coating composition of the present invention is useful for making films that subsequently are used to produce a packaging product such as for packaging fresh produce, frozen produce, meat, liquid foods, dry foods, and general snacks.

In some embodiment, the coating composition beneficially has a long pot life property. For example, pot life can be in the range of from 3 hours (hr) to 12 hr in one general embodiment; from 4 hr to 12 hr in another embodiment; from 5 hr to 10 hr in still another embodiment; and from 6 hr to 8 hr in yet another embodiment. In a preferred embodiment, the pot life of the coating composition is above 6 hr. A coating composition pot life of less than (<) 3 hr has a running ability problem during the composition's application processing. The pot life is measured by coating ability which means at the giving time still achieve acceptable coating appearance.

The coating composition useful in the present invention has several other beneficial properties compared to other known coating compositions including, for example, high gloss, excellent abrasion resistance, heat seal resistance, and low COF.

According to one or more embodiments, at least a portion of the outer surface of the coating layer surface of the coated film that comprises the coating layer has a desired optical finish of gloss. As is described herein, these optical properties are achieved by the presently disclosed processing steps during the fabrication of the coated film. For example, in one or more embodiments, at least a portion of a surface of the coated film that comprises the coating layer has a gloss of from 60 gloss units to 130 gloss units at 60° (sixty degrees). As described herein, gloss is measured by utilizing the ASTM D2457 standard. In additional embodiments, the gloss unit at 60° may be from 40 gloss units to 50 gloss units, from 50 gloss units to 60 gloss units, from 60 gloss units to 70 gloss units, from 70 gloss units to 80 gloss units, from 80 gloss units to 90 gloss units, from 90 gloss units to 100 gloss units, from 100 gloss units to 130 gloss units, or any combination thereof. For example, the gloss at 60° may be within the range of from 40 gloss units to 130 gloss units. In other embodiments, the gloss at 60° may be at least 50 gloss units, at least 60 gloss units, at least 70 gloss units, at least 80 gloss units, or at least 90 gloss units; up to ≤130 gloss units, ≤120 gloss units, ≤110 gloss units, ≤100 gloss units, or ≤90 gloss units.

In some embodiment, the coating layer beneficially has a high abrasion resistance. For example, the abrasion resistance can be in the range of ≥50 rub cycle times in one general embodiment according to Sutherland rub resistance test; from 50 rub cycle times to 2,000 rub cycle times in another embodiment; and from 50 rub cycle times to 1,000 rub cycle times in still another embodiment. An abrasion resistance that is lower than 50 rub cycles can cause packaging scratch and damage appearance during packaging processing and transportation. Therefore, the higher rub cycle times of ≥50 rub cycle times are preferred.

In some embodiment, the coating layer beneficially has a high thermal seal resistance on the one side of the coating layer to provide the film structure to be subjected to heat sealable conditions on the non-coated side. For example, the thermal seal resistance of the coating layer can be in the temperature range of ≥130° C. in one general embodiment; from 135° C. to 220° C. in another embodiment; from 140° C. to 210° C. in still another embodiment, and from 150° C. to 205° C. in yet another embodiment. A thermal seal resistance that is lower than 130° C. results in an inefficient heat seal; and a thermal seal resistance that is higher than 220° C. can result in failure of heat seal resistance of the coating side. Thus, issues related to pouching and the packaging processing line occur.

The coating weight of the coating layer on the polyolefin layer of the coated film structure can be in the range of from 1.1 grams per square meter (gsm or g/m²) up to 4.0 gsm in one general embodiment; and from 1.6 gsm to 3.2 gsm in another embodiment. A coating layer having a coating weight that is lower than 1.1 gsm results in less performance and a coating layer having a coating weight that is higher than 4.0 gsm can cause potential issues regarding appearance, higher cost, and drying efficiency, and the like.

Once the coating layer is applied to the polyolefin layer and cured, a coating layer is produced on the surface of one side of the polyolefin layer resulting in a coated film having a coated side and a non-coated side. In some embodiments, the non-coated side of the coated film has a sufficiently high heat sealability property such that the coated film can be formed into an article such as a packaging article under heat sealing conditions. For example, the heat scalability of the coated film can be in the temperature range of from 130° C. to 220° C. in one general embodiment; from 140° C. to 210° C. in another embodiment; and from 150° C. to 205° C. in still another embodiment. A coated film having a heat scalability that is lower than 130° C. results in heat-sealed articles, such as packages, that are inefficiently and unsatisfactorily heat-sealed; and in turn, leakage of the package occurs. A coated film having a heat sealability property that is higher than 220° C. can cause issues related to, for example, packaging appearance and heat seal resistance failure on the coating side which can lead to problems with the pouching and packaging processing line.

In some embodiments, the coated film also has the other beneficial properties including, for example, improved color retention of the polyolefin film.

The film structure of the present invention can include other optional substrate layers, component (c), in addition to the above component layers (a) and (b). For example, in some embodiments, the polyolefin film structure may include a printed layer on the top surface of the polyolefin layer, where the printed layer may be in contact with the coating layer; and thus, forming a multilayer film structure wherein the printed layer is disposed inbetween the polyolefin layer and the coating layer. In such embodiments, the coating composition may be applied directly onto the printed layer. The printed layer may be an ink layer to show product details and other packaging information in various colors. The printed layer may be ≤15 μm in one general embodiment, ≤10 μm in another embodiment, ≤5 μm in still another embodiment, and ≤2.5 μm in yet another embodiment.

In another embodiment, the printed layer may on another side of the coated polyolefin film, where further laminates with another heat sealable polyolefin film or another multilayer polyolefin films with laminating adhesives.

If desired, optional layers having a specific function such a sealant layer, a barrier layer, a tie layer, and the like, or their combination can be added to the coated film structure by either coextrusion or lamination through a laminating adhesive.

In one or more embodiments when an optional layer is used, the thickness of the optional layer can be, for example, from 1 μm to 100 μm in one embodiment, from 2 μm to 70 μm in another embodiment, and from 3 μm to 50 μm in still another embodiment.

In one broad embodiment, the heat sealable recyclable coated film of the present invention is produced by applying the coating composition described above onto the surface of the polyolefin film substrate to form a coating layer on the surface of the polyolefin film substrate. According to one or more embodiments, the coated film of the present invention may be made by a process generally comprising the steps of applying the uncured coating composition on at least a portion of the outer surface of the polyolefin film layer; and curing the uncured coating composition to form a coating layer on the polyolefin layer resulting in the coated film structure of the present invention. The application of the uncured coating composition may be such that the outer surface of the polyolefin layer is in contact with the inner surface of the coating layer.

For example, in one general embodiment, the process for producing the heat sealable recyclable film includes the steps of: (I) providing (a) a polyolefin film substrate; and (b) a coating composition; (II) applying the coating composition to at least a portion of the surface of the polyolefin substrate to form a coating layer; and (III) curing the recyclable coating composition to form a cured coating layer on the top surface of the polyolefin substrate of step (II) to form a coated film. As described herein, “applying” a coating composition to a polyolefin layer substrate may include bringing the coating composition into contact with the polyolefin layer by any conventional means known in the art of applying coating compositions or formulations to a film substrate. For example, the coating composition can be applied using conventional film forming equipment and processes, including gravure printing, flexographic printing, offset printing. Meyer rod drawdown, and the like. In some embodiments, the coating application process described above can be conducted before a lamination process step is used in one embodiment; or after a lamination process is used in another embodiment.

In one or more embodiments, the application of the uncured coating composition may be performed by a lamination process on a conventional lamination machine. For example, according to one or more embodiments, the uncured coating composition may be applied onto the polyolefin film layer as the polyolefin film layer is translated in a machine direction. That is, the polyolefin film layer may be conveyed in a machine direction while the uncured coating composition is applied. As described herein, the machine direction refers to the direction in which the film flows onto or into a processing machine, such as the laminator. The uncured coating composition may be deposited onto the polyolefin film layer with either smooth rolls or gravure rolls, which may be selected, at least in part, by the viscosity of the uncured coating composition. The polyolefin film layer may begin in a rolled form, to be unwound and conveyed in a machine direction where the uncured coating composition is applied to the polyolefin layer, and then the polyolefin layer is re-wound into a roll.

According to embodiments disclosed herein, following the application of the uncured coating composition, the uncured coating composition may be dried and cured to form the coating layer comprising the cured coating composition layer positioned on the surface of the polyolefin layer. The curing may be “passive,” meaning that the curing takes place by allowing the uncured coating composition to rest at ambient conditions for a period of time. Alternatively, the curing may be facilitated by exposure to increased temperatures, infrared (IR) radiation, or other mechanisms that may cause curing to take place in the coating composition. In some embodiments, the curing may take place while the polyolefin film layer and the uncured coating composition are in a roll following lamination. Following a period of time, the uncured coating composition solidifies and forms a roll of film comprising the coated film with the coating layer.

The coated film of the present invention can be used, for example, in packaging applications and laminate applications for packaging either food or non-food items; industries that readily utilize recyclable packaging. For example, the coated film of the present invention, prior to recycling, can be used in packaging applications for manufacturing various packaging materials and products. For example, the coated film can be used for bulk packaging of food grains/pulses, packaging of seeds, packaging of lentils and cereals, packaging of fertilizer, packaging of oilseed, packaging of sugar, packaging of salt, packaging of pharmaceuticals, packaging of other food stuff, and personal care items such as bath salts, detergent pods and the like. The coated film may also be used as a wrapper for baby wipes, feminine hygiene products, cereal bars, protein bars, cheese and confectionary products. Also, other advantageous features and applications for the recyclable film when used for packaging articles include, for example, resistance to severe weathering conditions, high tensile strength, robust drop test resistance, excellent optical appearance, and resistance to spills.

One of the advantages of the present invention is that a used virgin article made from the film of the present invention can be readily processed through a recycling process. After recycling, the recycled material from the previous virgin article can be used to make a subsequent recycled film; and in turn, the subsequent recycled film can be used to make a recycled article. The resultant subsequent recycled film can advantageously be used to manufacture a subsequent recycled article which has properties and performs very close to the previous virgin article. For example, a new monolayer recycled film structure made with recycled material from the recycled article can have properties that exhibits <50% change in performance relative to a control virgin film that is reprocessed the same without any recycled material. In some embodiments, the new monolayer film structure can have properties that exhibits a change in performance in the range of from 0% to <50% in one embodiment, from 0.01% to <40% in another embodiment, and from 0.1% to <30% in still another embodiment. The recycled film structure and the recycled film structure's recyclability performance meet the recyclability guidelines of The Association of Plastic Recyclers.

### EXAMPLES

The following Inventive Examples (Inv. Ex.) and Comparative Examples (Comp. Ex.) (collectively, “the Examples”) are presented herein to further illustrate the present invention in detail but are not to be construed as limiting the scope of the claims. Unless otherwise stated all parts and percentages are by weight.

Various materials used in the Examples which follow are described in Table I.

TABLE I
Raw Materials

| Material | Brief Description | Supplier |
|---|---|---|
| ROSHIELD ™ 3275 | An acrylic emulsion | Dow Inc. |
| | polymer. | |
| MOR-FREE ™ CR | A modified aliphatic | Dow Inc. |
| 9-101 | isocyanate coreactant. | |
| ACRYSOL ™ 2020E | A rheology modifier | Dow Inc. |
| | (urethane-based thickener. | |
| TRITON ™ GR-5M | A wetting agent additive. | Dow Inc. |
| TEGO ® Antifoam | An antifoaming agent | Evonik |
| 4-94 | additive. | |
| HYDROCER ™ 145 | A wax dispersion additive. | Shamrock |
| OPULUX ™ HGT | A solvent-based (SB) | Dow Inc. |
| 2020/2021 | gloss coating. | |
| OPULUX ™ HGT | A SB gloss coating. | Dow Inc. |
| 3020/3021 | | |
| ELITE ™ 5960 PE film | A multilayer HDPE film. | Dow Inc |
| TE-352 FG (DC) | A 40% active food | ICM Products |
| | grade emulsion. | Inc. |

### Examples 1-9 and Comparative Examples A and B-Coating Compositions

### Part A: General Procedure for Preparing Coating Formulations

The coating formulations of Inv. Ex. 1-9 described in Table II are prepared as follows:

Using a high-speed mixer, the components are mixed at a given amount as shown the formulations described in Table II. The acrylic emulsion polymer is first loaded into a mixing vessel followed by the defoamer. Then, the other additives, are added to the mixture in the mixing vessel, one by one, under mixing at room temperature (RT, about 23° C.).

The web coating is combined with water-dispersible aliphatic polyisocyanate at a proper mix ratio under an overhead mixer before applying coating composition onto the polyolefin film substrates. The coated film substrate is then dried in a drying oven at 90° C. for about 2 minutes (min).

The coating formulations of Comp. Ex. A and Comp. Ex. B described in Table III are prepared according to the recommendations set forth in the product manufacturer's Technical Data Sheet (TDS). For example, the coating formulations of Comp. Ex. A or B are prepared by mixing, with a high-speed mixer, the two components comprising the product under overhead mixing; and then the coating composition is coated on polyolefin substrates at the given mix ratio at RT and dried in a drying oven at 90° C. for about 2 min.

Comp Ex C is a non-coated polyethylene film of ELITE™ 5960 PE.

### Part B: General Procedure for Preparing Coated Film Samples

The wet coating composition, prepared using the procedure in Part A, is coated onto the surface of a HDPE film (made from ELITE 5960, 50 μm thickness) with a K-Coater with #2 drawdown bar. The targeted weight of the coating is from 3.0 g/m² to 3.5 g/m². A QD Printer with 120Q Anilox roll in flexographic proofer is also used to prepare coated film samples for testing in a flexographic printing process and targeting a coating weight of from 1.3 g/m² to 2.0 g/m².

The wet coating composition is dried for 2 min at 90° C. after applying the wet coating composition on the HDPE film, then the coated film sample is kept at RT for 7 days before subjecting the coated film sample to coating performance testing.

Table II describes the ingredients of the formulations and the properties of the formulations for the coating compositions of Inv. Ex. 1 to Inv. Ex. 9. The viscosity and pot life of the wet coating composition samples are measured. The viscosity is measured using a Signature-series viscosity cup, a Zahn #3 cup.

Table III describes two commercially available formulations and the properties of the formulations for the coating compositions of Comp. Ex. A and Comp. Ex. B. The viscosity and pot life of the wet coating composition samples are measured. The viscosity is measured using a Signature-series viscosity cup, a Zahn #2 cup.

TABLE II
Coating Compositions

| | Inv. | Inv. | Inv. | Inv. | Inv. | Inv. | Inv. | Inv. | Inv. |
|---|---|---|---|---|---|---|---|---|---|
| Material | Ex. 1 | Ex. 2 | Ex. 3 | Ex. 4 | Ex. 5 | Ex. 6 | Ex. 7 | Ex. 8 | Ex. 9 |
| ROSHIELD ™ 3275 | 65.56 | 76.67 | 84.36 | 83.85 | 84.75 | 84.87 | 84.93 | 85.05 | 72.23 |
| MOR-FREE ™ CR 9-101 | 6.03 | 6.31 | 7.76 | 7.71 | 7.40 | 7.41 | 7.42 | 7.43 | 6.31 |
| DI water | 27.10 | 15.33 | 5.62 | 5.59 | 5.65 | 5.66 | 5.66 | 5.67 | 19.68 |
| ACRYSOL 2020E | 1.31 | 0.77 | 0.84 | 0.84 | 0.85 | 0.85 | 0.85 | 0.85 | 0.72 |
| TRITON ™ GR-5M | | | 0.04 | 0.04 | 0.05 | 0.05 | 0.05 | 0.05 | 0.04 |
| TEGO ® Antifoam 4-94 | | 0.04 | 0.11 | 0.11 | 0.06 | 0.06 | 0.06 | 0.06 | 0.05 |
| butanol (99.9%) | | 0.03 | 0.06 | 0.06 | 0.06 | 0.06 | 0.06 | 0.06 | |
| 1,4-dimethylolcyclohexane | | | | | | | | | 0.14 |
| SLS (40%) | | | 0.84 | 0.84 | 0.85 | 0.85 | 0.57 | 0.57 | 0.48 |
| oleic acid (97%) | | | 0.01 | 0.01 | 0.01 | 0.01 | 0.02 | 0.02 | 0.04 |
| ammonia (27%) | | | 0.06 | 0.06 | 0.06 | 0.06 | 0.11 | 0.11 | 0.09 |
| TE-352 FG (DC) | | 0.46 | 0.28 | 0.28 | 0.28 | 0.14 | 0.28 | 0.14 | 0.24 |
| polyacrylic acid | | 0.40 | | | | | | | |
| HYDROCER ™ 145 | | | | 0.61 | | | | | |
| Total (g) | 100.00 | 100.00 | 100.00 | 100.00 | 100.00 | 100.00 | 100.00 | 100.00 | 100.00 |
| Properties | | | | | | | | | |
| Viscosity (second) | 27.5 | 20.2 | 23.5 | 23.7 | 17.8 | 17.9 | 33.1 | 34.2 | 9.39 |
| pH* | 8.0 | 7.6 | 8.2 | 8.2 | 8.3 | 8.3 | 8.4 | 8.4 | 8.2 |
| Appearance | milk | milk | milk | milk | milk | milk | milk | milk | milk |
| | white | white | white | white | white | white | white | white | white |
| Pot life (hr) | >8 | >8 | >8 | >8 | >8 | >8 | >8 | >8 | >8 |

*measured before mixing with MOR-FREE ™ CR-9-101

TABLE III
Coating Compositions

| Material | Comp. Ex. A | Comp. Ex. B |
|---|---|---|
| OPULUX ™ HGT 3020/3021 | 100/87 | |
| (weight), solvent based | | |
| OPULUX ™ HGT 2020/2021 | | 100/100 |
| (weight), solvent based | | |
| Properties | | |
| Mixing viscosity 35% solid content | 12.7 | 18 |
| (Zahn Cup#2, second)** | | |
| Pot life, hr | 4 | 4 |

**use Signature Zahn#2 cup due to low viscosity.

### Comparative Example C

Comp. Ex. C is a HDPE multilayer film itself (ELITE™ 5960) having a thickness of 50 μm.

### Examples 10-18 and Comparative Examples D and E-Coated Films

### Coating Performance Tests

The cured coatings were tested for gloss of 60° and 20° (twenty degrees) based on ASTM D2457. Gloss was measured with a glossmeter at RT.

The cured coatings were tested for face-to-face Sutherland abrasion. Sutherland abrasion was tested with a SUTHERLAND® 2000 RUB tester and a 1.81 kilograms (kg) weight loading according to ASTM D5265.

The COF of the cured coatings was measured with a COF tester from Testing Machines Inc. in a control room (at 25° C., 50% humidity).

Thermal seal resistance was evaluated by heat sealing the coating side face to face at 205° C. with 0.276 MPa pressure and a 1-second duration time using a heat sealer with Teflon coated heating jaws. The coating was designated as “Pass” when the coating did not stick together and the film did not significantly shrink after sealing. The coating was designated as “Fail” when the coating stuck together and/or the film significantly shrank after scaling. Table IV describes the coating performance results of the coated films.

TABLE IV
Performance of Gloss Coatings from K-Coater Drawdown

| Example | Inv. | Inv. | Inv. | Inv. | Inv. | Inv. | Inv. | Inv | Inv. Ex. | Comp. | Comp. | Com [symbol] |
|---|---|---|---|---|---|---|---|---|---|---|---|---|
| of Coated Film: | Ex. 10 | Ex. 11 | Ex. 12 | Ex. 13 | Ex. 14 | Ex. 15 | Ex. 16 | Ex. 17 | 18**** | Ex. D | Ex. E | Ex. [symbol] |
| Example of Coating | Inv. | Inv. | Inv. | Inv. | Inv. | Inv. | Inv. | Inv. | Inv. | Comp. | Comp. | — |
| Composition Used to | Ex. 1 | Ex. 2 | Ex. 3 | Ex. 4 | Ex. 5 | Ex. 6 | Ex. 7 | Ex. 8 | Ex. 9 | Ex. A | Ex. B | |
| Make Coated Film: | | | | | | | | | | | | |

Performance Property

| | | | | | | | | | | | | |
|---|---|---|---|---|---|---|---|---|---|---|---|---|
| Gloss, 20° | 26.1 | 15.5 | 32.0 | 29.0 | 28.7 | 30.4 | 30.6 | 28.0 | 55.1 | 25.4 | 26.0 | 14.30 |
| Gloss, 60° | 82.1 | 81.4 | 106.6 | 95.0 | 100.7 | 100.6 | 100.0 | 96.2 | 84.7 | 113.7 | 114.2 | 44.28 |
| COF, static (coating/ | 0.772 | 0.357 | 0.287 | 0.261 | 0.278 | 0.290 | 0.266 | 0.402 | 0.323 | 0.554 | 0.462 | 0.297 |
| coating) | | | | | | | | | | | | |
| COF, kinetic (coating/ | 0.679 | 0.197 | 0.258 | 0.182 | 0.276 | 0.277 | 0.252 | 0.396 | 0.283 | 0.498 | 0.442 | 0.265 |
| coating) | | | | | | | | | | | | |
| COF, static (coating/ | —*** | —*** | 0.218 | 0.232 | 0.290 | 0.277 | 0.274 | 0.321 | 0.320 | 0.381 | 0.387 | 0.229 |
| steel panel) | | | | | | | | | | | | |
| COF, kinetic (coating/ | —*** | —*** | 0.216 | 0.200 | 0.279 | 0.281 | 0.263 | 0.317 | 0.299 | 0.408 | 0.383 | 0.198 |
| steel panel) | | | | | | | | | | | | |
| Thermal seal resistance | PASS | PASS | PASS | PASS | PASS | PASS | PASS | PASS | PASS | PASS | PASS | FAIL |
| (at 205° C., 1 second) | | | | | | | | | | | | |
| Abrasion resistance | 50-80 | >100 | >100 | >100 | >100 | >100 | >100 | >100 | 50-60 | <20 | <20 | <20 |
| (Sutherland rub, | | | | | | | | | | | | |
| 1.81 kg weight, | | | | | | | | | | | | |
| number of rub cycles) | | | | | | | | | | | | |

***Not tested
****coated film sample was prepared using a Labocombi pilot coater at 122 M/min on 50 μm HDPE; data was collected after 7 days of curing the sample at room temperature; coating weight = 1.5 g/m² [symbol]
indicates data missing or illegible when filed

TABLE V
Performance of Gloss Coating from QD Printer Flexographic Proofer

| Example of Coated Film: | Inv. Ex. 19 | Inv. Ex. 20 | Inv. Ex. 21 | Inv. Ex. 22 |
|---|---|---|---|---|
| Example of Coating | Inv. Ex. 5 | Inv. Ex. 6 | Inv. Ex. 7 | Inv. Ex. 8 |
| Composition Used to | | | | |
| Make Coated Film: | | | | |
| Performance Property | | | | |
| Gloss, 20° | 25.2 | 27.0 | 27.9 | 26.2 |
| Gloss, 60° | 95.4 | 93.9 | 102.9 | 91.4 |
| COF, static | 0.393 | 0.415 | 0.341 | 0.417 |
| (coating/coating) | | | | |
| COF, kinetic | 0.341 | 0.381 | 0.319 | 0.388 |
| (coating/coating) | | | | |
| COF, static | 0.340 | 0.344 | 0.298 | 0.380 |
| (coating/steel) | | | | |
| COF, kinetic | 0.335 | 0.350 | 0.299 | 0.384 |
| (coating/steel) | | | | |
| Abrasion resistance | >100 | >100 | >100 | >100 |
| (Sutherland Rub, | | | | |
| 1.81 kg weight, | | | | |
| number of rub cycles) | | | | |
| Thermal seal resistance | Pass | Pass | Pass | Pass |
| (at 205° C., 1 second) | | | | |

It will be apparent that modifications and variations are possible without departing from the scope of the present invention defined in the appended claims. More specifically, although some aspects of the present invention are identified herein as preferred or particularly advantageous, it is contemplated that the present invention is not necessarily limited to these aspects.

It will be apparent with the claims that use of the singular also includes the possibility of the plural. For example, reference to a coating layer also implicitly includes reference to at least one coating layer.

It is noted that one or more of the following claims utilize the term “wherein” as a transitional phrase. For the purposes of defining the present invention, it is noted that the term “wherein” is introduced in the claims as an open-ended transitional phrase that is used to introduce a recitation of a series of characteristics of the structure and should be interpreted in like manner as the more commonly used open-ended preamble term “comprising.”

What is claimed is:

1. A glossy coated film having recyclability properties for packaging articles, the coated film comprising a combination of:
(a) at least one film layer of a recyclable polyolefin; and
(b) at least one coating layer disposed on a portion of one surface of the at least one film layer of the recyclable polyolefin; wherein the at least one coating layer comprises a waterborne coating composition; wherein the coating layer has: (1) a thermal seal resistance of greater than or equal to 130° C.; (2) an abrasion resistance of greater than or equal to 50 rub cycles under a 1.81 kilogram weight loading; (3) a glossy property of 60° of greater than or equal to 90 gloss units; and (4) a recyclability property of less than a 50 percent change in performance compared to a film without the coating layer.

2. The film of claim 1, wherein the thermal seal resistance is from 130° C. to 220° C.; wherein the abrasion resistance is from 50 rub cycles to 2,000 rub cycles; wherein the glossy property of 60° is from 90 gloss units to 130 gloss units; and wherein the recyclability property is from 0.01 percent to less than a 50 percent change in performance relative to a control virgin film that is reprocessed the same way without any recycled material.

3. The film of claim 1, wherein the at least one film layer of a recyclable polyolefin is a polyethylene.

4. The film of claim 1, wherein the at least one coating layer is a waterborne acrylic coating formulated with a hydroxyl functionalize emulsion and additives without inorganic pigment materials; and wherein the waterborne acrylic coating cured with a water-dispersible aliphatic polyisocyanate.

5. A packaging article made from the glossy coated film of claim 1.

6. A recycled article made from the glossy coated film of claim 5.

7. A process for producing a glossy coated film having recyclability properties comprising the steps of:
(I) providing:
(a) a recyclable polyolefin film substrate; and
(b) a waterborne coating composition;
(II) applying the waterborne coating composition of step (I) to at least a portion of the surface of the polyolefin substrate to form a waterborne coating composition coating layer; and
(III) curing the waterborne coating composition to form a cured coating layer disposed on at least a portion of one surface of the polyolefin substrate of step (II) to form a coated film; wherein the coating layer has: (1) a thermal seal resistance of greater than or equal to 130° C.; (2) an abrasion resistance of greater than or equal to 50 rub cycles under a 1.81 kilogram weight loading; (3) a glossy property of 60° of greater than or equal to 90 gloss units; and (4) a recyclability property of less than a 50 percent change in performance compared to a polyolefin film without the coating layer.

8. A process for producing a recycled film article comprising the steps of:
(i) providing a packaging article of claim 4;
(ii) fragmenting the packaging article from step (A) to a plurality of fragments of a predetermined size;
(iii) pelletizing the plurality of fragments from step (B) to form a plurality of pellets of a predetermined size; and
(iv) processing the pellets from step (C) to form a recycled film article.

9. A recycled film article produced by the process of claim 8.

10. A waterborne coating composition comprising:
(A) at least one hydroxyl functionalized emulsion polymer;
(B) at least one crosslinker;
(C) water; and
(D) at least one urethane-based thickener; and
(E) at least one slip agent;
(F) at least coalescing agent
wherein the waterborne coating composition provides a coating layer on a polyolefin film substrate; wherein the coating layer has (1) a thermal seal resistance of greater than or equal to 130° C.; (2) an abrasion resistance of greater than or equal to 50 rub cycles under a 1.81 kilogram weight loading; (3) a glossy property at 60° of greater than or equal to 90 gloss units; and (4) a recyclability property of less than a 50 percent change in performance compared to a film without the coating layer.
